(19) United States
(12) Patent Application Publication
(10) Pub. No.: US 2004/0018634 A1
(43) Pub. Date: Jan. 29, 2004

(54) Sample-collection and preparation device and method

(76) Inventors: Kiamars Hajizadeh, Lincolnshire, IL (US); Peter Lewis, Streamwood, IL (US); Kelly Mills, McHenry, IL (US)

Correspondence Address: ROGER H. STEIN, ESQ., WALLENSTEIN & WAGNER, LTD., 311 SOUTH WACKER DRIVE, 53rd FLOOR, CHICAGO, IL, 60606-6630, US

(21) Appl. No.: 10/208,179

(22) Filed: Jul. 29, 2002

(51) Int. Cl. G01N 1/00

(52) U.S. Cl. 436/174; 436/179; 436/180; 422/99; 422/100; 422/102

(57) ABSTRACT

Devices and methods are provided for collecting a sample, diluting the sample in a buffer, and dispensing it for analysis by a method of choice. The devices comprise a dropper top dispensing component having a housing and an elongated swab member inserted in the dropper top and having a swab end with an absorbent for collecting a sample. Also included is a vial that contains a buffer and is attachable to the dropper top so as to immerse the absorbent in the buffer after the absorbent has been used to collect the sample. One embodiment incorporates a dispensing chamber within the dropper top for controlling the amount of sample dispensed from the device, so the device is capable of dispensing sample in drop-sized increments. The method comprises (a) providing a device according to the invention, (b) collecting a test sample by contacting, with the absorbent, one of a surface and a fluid sample suspected of being contaminated with the analyte, such as an anthrax analyte; (c) releasing the test sample into the buffer by immersing the sample-containing absorbent in the buffer under agitation to form an analysis-ready sample; and (d) dispensing the analysis-ready sample into an assay for the analyte. The devices and methods may be used to prepare samples for analysis of a variety of analytes, including coliforims, mold spores, bacterial spores such as spores from Bacillus anthracis and Clostridium species, mycotoxins, allergens, toxins, environmental contaminants, and water additives, as examples.

### TECHNICAL FIELD

This invention relates to devices and methods for collecting and preparing samples for analysis by a method of choice. In particular, the invention relates to devices and methods for collecting a sample of an analyte, diluting the sample in a buffer, and dispensing it for use in an assay for detecting the analyte. In one embodiment, the analyte includes at least one of the anthrax endospores and the causative organism.

### BACKGROUND OF INVENTION

Before virtually any analytical procedure may be utilized, it requires that a representative test sample be collected from the material to be analyzed and that the sample be prepared in a manner appropriate for the analysis. The steps used to prepare the sample vary, depending upon the particular analyte. Generally, however, after a sample is obtained for analysis, one of the first steps involves reducing the sample matrix into smaller-sized units—whether that be particles, strands, or bits and pieces of the sample. At the same time, the sample is generally liquefied or diluted with a buffer so it may be introduced into the analytical procedure. Additional sample preparation may include extracting the desired analyte into the buffer.

A number of sample preparation methods are at the disposal of researchers. Some devices and methods are labor intensive and require extensive steps before yielding even a small aliquot of an “analysis-ready” sample. For example, separation techniques such as centrifugation may be burdensome, as they take time to fill the centrifuge tubes and load and unload the centrifuge.

Efforts have been made to simplify the extraction of analytes. For example, in U.S. Pat. No. 6,090,572, Croby discloses a device for filtering a biological fluid and extracting an analyte from the fluid. The device has a pliant body with a sealable open top and a gradient filter assembly. A biological fluid is introduced into the device through the open top, which is then sealed. By squeezing the device, the user creates a positive pressure that causes the biological fluid to flow through the filter so particulates—such as Chlamydia and/or Neisseria gonorrhea—may be captured on the filter. The top end may then be opened and a reagent, such as a protease extraction reagent, added. The top is re-sealed, and the user squeezes the pliant body again so the reagent flows through the filter assembly and extracts the desired analyte from the microorganisms held on the filter. The clarified liquid is then expressed through the opposite end of the device. Although this device works for biological liquids, it lacks utility for materials such as certain foods and biological tissues and organs and requires addition of the reagent(s).

One analyte attracting greater attention today is the anthrax spore. Anthrax, an infectious disease caused by the spore-forming bacterium, Bacillus anthracis, affects humans as wells as animals such as cattle, horses, mules, and goats. Although anthrax disease can be found worldwide, it occurs more commonly in developing countries or those that lack veterinary public health programs. Certain regions of the world—such as South and Central America, South and Eastern Europe, Asia, Africa, the Caribbean, and the Middle East—report a higher incidence of anthrax in animals than others.

In the United States, anthrax occurs in nature sporadically when favored by environmental conditions; e.g., when spore-harboring ponds frequented by animals begin to evaporate, increasing the concentration of spores in the water. According to the United States Department of Agriculture, an outbreak of anthrax occurred in deer and livestock in Del Rio, Tex., in September 2001. Other outbreaks have affected cattle and horses in Minnesota in June-July 2000, bison in North Dakota in August 2000, and cattle in Nebraska in January 2001.

The bacterium may be spread by streams, insects, wild animals, birds, and contamination from wastes of infected animals. Humans may contract the disease by, e.g., handling products from infected animals, inhaling spores from contaminated animal products, or eating undercooked meat from infected animals. More recently, the disease has generated worldwide concern as a potential agent in biological warfare.

Detection of anthrax spores is of paramount interest worldwide. One challenge in the analytical procedure, however, concerns maintaining sterility by minimizing cross-contamination of test samples when collecting the spores from surfaces and when delivering the diluted test sample for analysis. Although several sampling devices exist, some specific for anthrax, the current devices are generally targeted to a particular type of sampling—i.e., certain products are required for sampling large surfaces, others for small surfaces, and still others for animal products. Moreover, the current devices are not capable of dispensing drop-sized aliquots of the diluted sample and frequently require multiple nonintegrated components, which may compromise sterility and complicate the utility of the device.

Thus, there exists a need for a simplified device and method for collecting and diluting a sample for analysis, including instances where the analyte is an anthrax analyte.

### SUMMARY OF THE INVENTION

The present invention provides devices and methods for collecting and diluting a sample for direct analysis of an analyte by a method of choice. In a preferred embodiment of the device and method, the analyte is an anthrax analyte.

To this end, in one aspect of the invention, a device is provided for collecting and preparing a sample for analysis of an analyte. In one embodiment, the analyte is an anthrax analyte. The device comprises a dispensing component, an elongated member with an absorbent for collecting the test sample, and a vial containing a buffer for diluting the analyte for delivery into an assay for the analyte. The dispensing component has a housing defining a recess, a top end with a pore therethrough, and an opposed open end. The elongated member has the absorbent at one end and is attachable at an opposite end inside the housing and extends away from the attached end beyond the open end of the dispensing component. The vial contains a buffer and is attachable to the open end of the dispensing component as to enclose the elongated member.

In another embodiment, a device is provided for collecting and diluting a sample for direct analysis of an anthrax analyte. This device comprises a dispensing component, a separate vial that is attachable to the dispensing component to form a closed dispenser, and structures—such as complementary threading ridges on interfacing surfaces—for screwing and attaching the vial to the dispensing component. The dispensing component has a housing defining a recess, a dispensing end with a pore therethrough and an opposed open end. The vial contains a buffer and is attachable to the open end of the dispensing component. Also included is an elongated member having an attaching end and an opposed swab end with an absorbent affixed on the swab end, and a structure for securing the attaching end to the housing. The elongated member also has a length sufficient for the swab end to extend beyond the open end of the dispensing component when the elongated member is attached inside the recess to the housing.

In another aspect of the invention, a method is provided for collecting and diluting a sample for analysis of an analyte. The method includes (a) providing a device, substantially as described above, comprising a dispensing component with a housing, and an elongated member attached to an inner surface of the housing. A separate vial containing a buffer is also provided and is attachable to the dispensing component so as to form an enclosed dispenser. As previously described, the dispensing component has a housing defining a recess, a dispensing end with a pore, and an opposed open end. When attached to the housing, the elongated member extends through the housing away from the dispensing end, terminating outside the open end in a swab end with an absorbent affixed thereon. The device includes a dropper cap that is attachable to the dispensing component for sealing the pore. The method also includes (b) collecting a test sample by contacting, with the absorbent, a surface suspected of containing an analyte; (c) releasing the test sample into the buffer by contacting the sample-containing absorbent with the buffer under agitation to form an analysis-ready sample; and (d) dispensing the analysis-ready sample into an assay for analysis of the analyte.

In a further aspect of the invention, a method is provided for collecting and diluting a sample for analysis of an anthrax analyte. The method includes (a) providing a device as described above; (b) collecting a test sample by contacting, with the absorbent, one of a surface and a fluid sample suspected of being contaminated with an anthrax analyte; (c) releasing the sample into the buffer by contacting the sample-containing absorbent with the buffer under agitation to form an analysis-ready sample; and (d) dispensing the analysis-ready sample into an assay for the anthrax analyte.

Other aspects of the invention will become apparent when taken in conjunction with the following description and drawings.

### BRIEF DESCRIPTION OF THE DRAWINGS

To understand the present invention, it will now be described by way of example, with reference to the accompanying drawings in which:

FIG. 1 is a perspective view of an assembled device 10 and vial cap 56, made in accordance with the invention;

FIG. 2 is of cross-sectional view of the closed dispenser 16, taken along lines 2-2 of FIG. 1, with dropper cap 40;

FIG. 3 is a perspective view of a dispensing component;

FIG. 4 is a perspective view of a dropper cap;

FIG. 5 is a cross-sectional view of another embodiment of the dispensing component, showing a face separating the recess from a dispensing chamber; and, FIG. 6 is a cross-sectional view of a vial cap.

### DETAILED DESCRIPTION OF THE INVENTION

While this invention is susceptible of embodiments in many different forms, preferred embodiments of the invention are illustrated in the drawings and described in detail herein, with the understanding that the present disclosure is to be considered as an exemplification of the principles of the invention and is not intended to limit the broad aspect of the invention to the embodiments illustrated.

This invention is directed to devices and methods for collecting a sample for subsequent and direct analysis of an analyte, such as anthrax analyte.

The following terms having the following meanings:

“Anthrax analyte” means at least one analyte selected from the group consisting of endospores produced by B. anthracis and the disease-causative microorganism itself.

“Biological sample” means a fluid sample of biological origin from a human or animal, such as blood, serum, plasma, nasal secretions, saliva, vaginal secretions, urine, bladder washings, colon washings, cerebral spinal fluid, and fluid from body systems such as the respiratory, circulatory, reproductive, and digestive systems, as examples.

A. The Devices

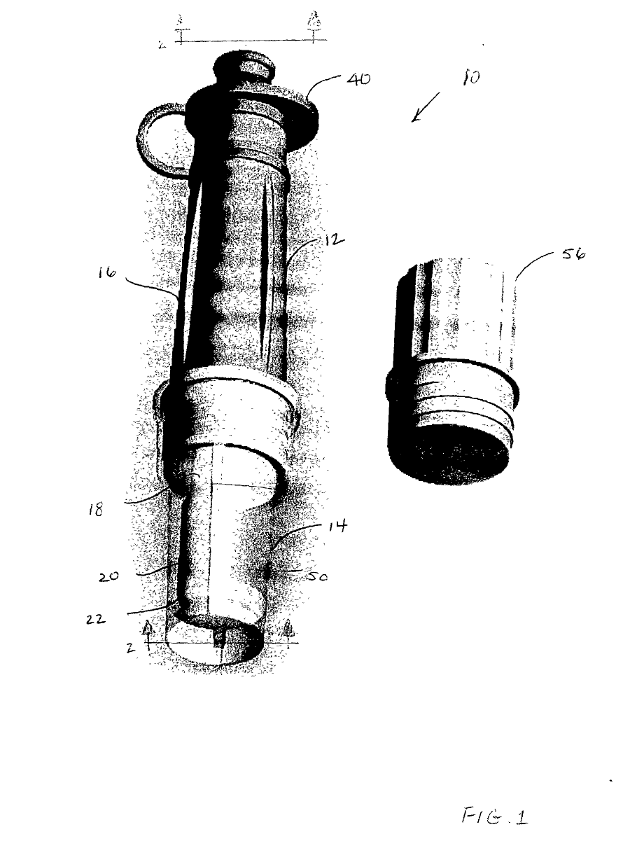

Shown in FIG. 1 is a sample collection and dilution device 10 and vial cap 56. The device 10 is typically disposable and easy-to-use for collecting a test sample, diluting the test sample with a buffer 50 to release the analyte of interest into the buffer 50, and dispensing the diluted sample into another device employing an analytical procedure for the targeted analyte. In one embodiment, the analyte is an anthrax analyte.

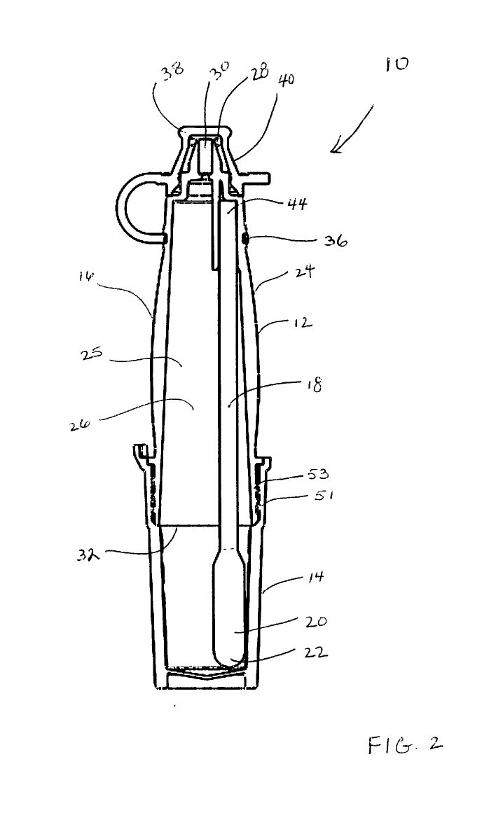

Shown in FIGS. 1 and 2, the device 10, in an assembled form, includes a dispensing component 12, a vial 14 attached to the dispensing component 12 to form a closed dispenser 16, and an elongated member 18 attached inside the dispensing component 12. An absorbent 20 is disposed on a swab end 22 that extends into the vial 14 and is enclosed within the dispenser 16 so formed.

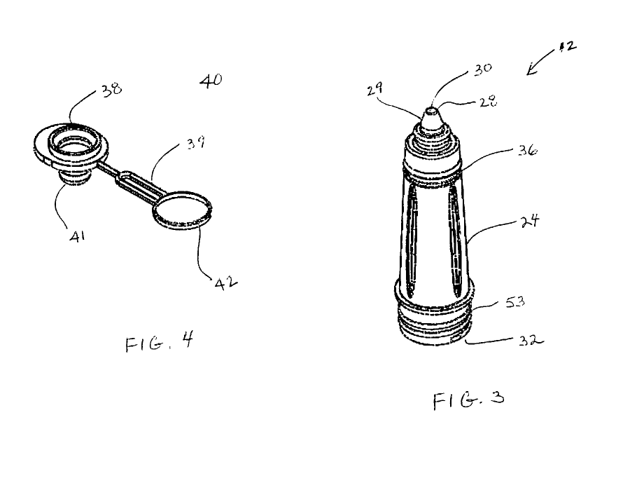

The dispensing component 12 has a housing 24 defining a recess 26, a dispensing end 28 with a pore 30 therethrough, and an opposed open end 32. As shown in FIG. 3, the dispensing end 28 has a conical configuration with the pore 30 disposed at the apex of the cone and a casing 29 of the dispensing end 28 extending downwardly away from the pore 30 and terminating at a neck 36. The dispensing end 28 is not, however, restricted to this configuration.

The pore 30 is configured to release the contents of the dispenser 16 in a drop-wise fashion, allowing the user to meter out a predetermined amount of the diluted, buffered test sample.

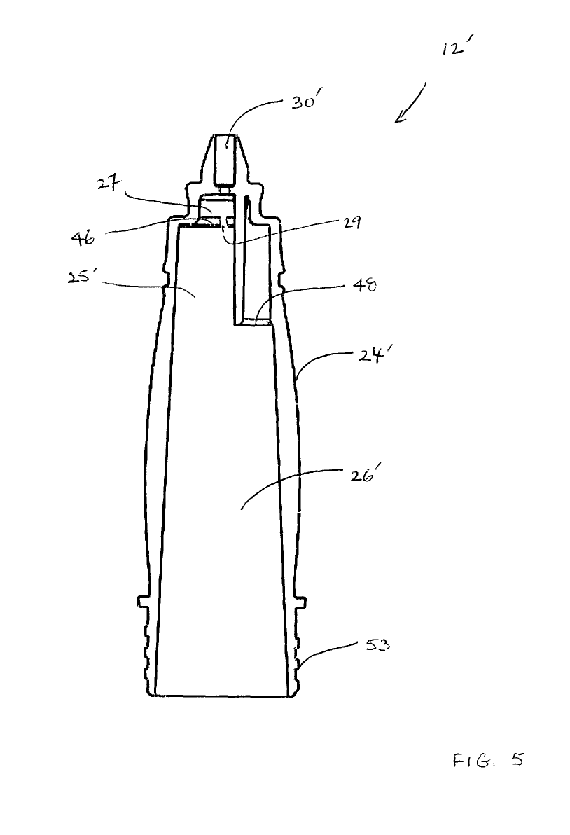

The dispensing component 12 also includes a releasable pore seal 38 over the pore 30 for preventing cross-contamination of the sample before the sample is dispensed for analysis. Although the pore seal 38 is typically a dropper cap 40 as shown in FIGS. 1 and 2, the pore seal 38 may have any number of embodiments. For example, the pore seal 38 may be a flap affixed to the device 10 that is releasably folded over the pore 30, a structure that snaps onto the dispensing end 28, a removable strip affixed to the device 10 over the pore by any suitable means, and any other structure that protects the pore 30 from contamination. One embodiment of the pore seal 38, shown in FIG. 4, is a dropper cap 40. Typically, the device 10 includes structures for attaching the dropper cap 40 to the dispensing component 12 so the dropper cap 40 may be removed to expose the pore 30 but yet remain tethered to the device 10. Shown in FIG. 4, the dropper cap 15 40 includes a caplet 41, a ring 42 that fits into the neck 36, and a flexible band 39 that attaches the ring 42 to the caplet 41.

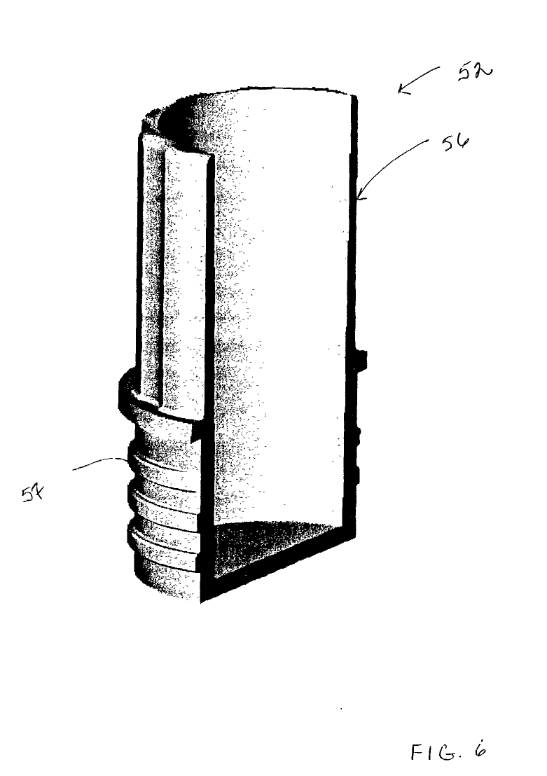

The elongated member 18, attached inside the recess to the housing 24, has an attaching end 44, a swab end 22 with an absorbent 20 affixed thereon, and a length sufficient for the swab end 22 to extend the length of the housing 24 and beyond the open end 32 of the dispensing component 12. In one embodiment, the dispensing component 12 includes structures secured to the housing 24 for attaching the elongated member 18 to the housing 24. In another embodiment of the dispensing component 12′, shown in FIG. 5, the housing 24′ includes a face 46 attached to an interior surface 25′ of the housing 24′ and extending across at least a portion of a cross-section of the housing 24′. The face 46 has an insertion opening 48 for inserting the attaching end 44 of the elongated member 18 therein. The face 46 is disposed substantially across the cross-section of the housing 24′ so as to separate the recess 26′ from a dispensing chamber 27 that is formed between the face 46 and the pore 30′. In this embodiment, the face 46 includes at least one vent 29 that allows the analysis-ready sample to incrementally enter the dispensing chamber 27 and be released in a controlled manner i.e., drop by drop—from the pore 30′.

The absorbent 20 is typically a material selected from the group consisting of gauze, cotton, a sponge, polyurethane, and cellulose fiber, as examples. Preferably, the absorbent 20 is polyurethane.

The vial 14 holds a sterile buffer 50 and is attached to the open end 32 of the dispensing component 12. The buffer 50 will vary from application to application, depending upon the analyte. Because the selection of a suitable buffer is known to those skilled in the art, buffers will not be discussed here in detail.

The vial 14 has a height 49 sufficient to enclose the elongated member 18 within a dispenser 16 formed upon attaching the vial 14 to the dispensing component 12. When so attached, the swab end 22 is substantially immersed in the buffer 50, as shown in FIG. 1.

The interfacing surfaces of the vial 14 and the dispensing component 12 typically have structures for attaching the two components to each other. For example, attachment is provided by complementary threading ridges 51,53 on interfacing surfaces of the vial 14 and the dispensing component 12, respectively, for screwing the two components together. Any other suitable structures for attachment may be used, however.

Before the vial 14 is attached to the dispensing component 12, the vial 14 has a removable vial seal 52 that seals the buffer 50 within the vial 14. The vial seal 52 is removed before the vial 14 may be secured to the dispensing component 12. The vial seal 52 may have a variety of forms such as a hermetically applied seal, a screw top, or a vial cap, as examples. FIG. 6 shows a cross-sectional view of one embodiment of a vial cap 56 having threading ridges 57 that correspond to threading ridges 51 on vial 14 for screwing the two components together.

The dispensing component 12, the elongated member 18, the vial 14, and the vial cap 56 are fabricated of a rigid material selected from the group consisting of polyethylene, polypropylene, polycarbonate, and polymetacrylate. The dispensing component 12, the elongated member 18, the vial 14, and the vial cap 56 are typically fabricated by injection molding.

B. The Methods

In another aspect of the invention, a method is provided for collecting a test sample, diluting the test sample with a buffer to release the analyte of interest into the buffer, and dispensing the diluted buffered sample into another device employing an analytical procedure. The present method may be used for collecting a test sample that is topically disposed on a surface. In one embodiment, the sampling site is a surface suspected of being contaminated with the analyte of interest such as a surface in a food processing facility such as a meat processing plant, in an office building, on an envelope, on equipment, in a grain silo, on rocks near ponds, or on foliage in an agricultural area, as examples. In another embodiment, the sample is a fluid sample, such as a biological fluid, water, and a beverage, as examples.

In one embodiment, the analyte is an anthrax analyte suspected of contaminating a surface or contained in a biological sample. The inventive method is not, however, restricted solely to the collection of an anthrax analyte. Instead, the method has broad-sweeping applications for collecting samples for analysis of a variety of analytes, including, as examples, coliforms such as Eschericia coli, allergens such as peanut dust, mycotoxins, mold spores, bacterial spores such as Clostridium botulinum and C. perfringens, ricin, small pox, environmental contaminants, toxins, water additives, and agricultural markers. For example, the method may be used in a food processing facility to check equipment for cross-contamination of, e.g., allergens such as peanut dust. The method may also be used to collect grain dust from freight cars, grain silos, and food processing equipment and other sites for subsequent analysis for aflatoxin or vomitoxin.

The method includes providing a device 10, as described above, for collecting and diluting a sample for subsequent analysis. As discussed, the device comprises a dispensing component 12, an elongated member 18 that is attachable to the dispensing component 12 and has a swab end 22 and an absorbent 20 disposed on the swab end 22, and a vial 14 that is attached to the dispensing component 12 to form a dispenser 16. The dispenser 16 encloses the elongated member 18 and the absorbent 20. In one embodiment, the device includes a dropper cap 40 that is attached to the dispensing component 12 for covering a pore 30 in the dispensing end 28. In yet another embodiment, the device includes a removable vial cap 56 or other seal, as noted above, that seals the vial 14 until it is ready to use.

As described above, the dispensing component 12 includes a housing defining a recess, a dispensing end 28 with a pore, and an opposed open end 32. Initially sealed until ready for use, the vial 14 contains a suitable buffer 50 for the analyte of interest, which in a preferred embodiment is an anthrax analyte.

To use the device, the user removes the plug cap or other seal from the vial 14. The user assembles the sampling device 10 by attaching the elongated member 18 to an interior surface 25 of the housing 24 by, e.g., inserting the attaching end 44 into a face 46 in the housing 24, as provided in one embodiment. Once attached, the elongated member 18 extends directionally away from the dispensing end 28 and terminates in the swab end 22 outside the open end 32 of the dispensing component 12. The dropper cap 40 is also affixed to the dispensing component by, e.g., slipping the ring 42 into the neck 36 beneath the dispensing end 28.

The next step includes collecting a test sample by contacting the absorbent 20 with the test sample suspected of containing the analyte. In one embodiment, the collecting step includes swabbing with the absorbent 20 a surface suspected of being contaminated with the analyte to collect a test sample. Prior to the absorbent 20 contacting the surface, the method usually comprises wetting the absorbent 20 with the buffer 50 to facilitate uptake of the sample. In another embodiment, the collecting step includes contacting the absorbent 20 with a fluid biological sample to be analyzed and allowing the absorbent 20 to absorb the biological sample.

The next step involves releasing the test sample into the buffer 50 by immersing the sample-containing absorbent in the buffer 50 under agitation to form an analysis-ready sample. In this step, the vial 14 is attached to the open end 32 of the dispensing component 12 so the sample-containing absorbent 20 is at least partially immersed in the buffer 50. The device and its contents are gently shaken so the agitation of the buffer 50 with respect to the absorbent 20 causes the sample to be released into the buffer 50, forming an analysis-ready sample.

In the step that follows, the analysis-ready sample is dispensed into another device employing a procedure for analysis of the analyte. The dispensing step involves removing the dropper cap 40 and inverting the device 10 to allow an aliquot of the analysis-ready sample to drip out through the pore 30. Typically, the dispensing step includes dispensing the analysis-ready sample into at least one test container for analysis of the analyte. In another embodiment, the dispensing step includes introducing the diluted sample into a device employing a procedure selected from the group consisting of immunoassay, immunochromatography, radio immunoassay, optical immunoassay, enzyme immunoassay, and chemiluminescence. In a further embodiment, the dispensing step includes dispensing the analysis-ready sample into an assay for an anthrax analyte. In yet another embodiment, the dispensing step includes dispensing the analysis-ready sample into a lateral flow device that detects and optionally quantifies the analyte in the sample.

While the specific embodiments have been illustrated and described, numerous modifications come to mind without significantly departing from the spirit and scope of the invention. All such modification are intended to be within the scope of the accompanying claims.

We claim:

1. A device for collecting and preparing a sample for direct analysis of an analyte, comprising:
a dispensing component having a housing defining a recess, a top end with a pore, and an opposed open end;
an elongated member having an absorbent at one end and being attachable at an opposite end inside the housing and extending beyond the open end of the dispensing component; and,
a vial having a buffer attachable to the open end of the dispensing component as to enclose the elongated member.

2. The device of claim 1 wherein the dispensing component further includes a releasable pore seal over the pore.

3. The device of claim 2 wherein the pore seal is selected from the group consisting of a removable strip, a cap, a flap, and a structure that snaps over the pore.

4. The device of claim 2 wherein the dispensing component, the elongated member, and the vial are produced by injection molding.

5. The device of claim 1 wherein the dispensing component, the elongated member, and the vial are fabricated from a material selected from the group consisting of polyethylene, polypropylene, polycarbonate, and polymetacrylate.

6. The device of claim 1 wherein the absorbent is a material selected from group consisting of gauze, cotton, a sponge, polyurethane, and cellulose fiber.

7. The device of claim 1 wherein the analyte is an anthrax analyte.

8. The device of claim 1 wherein the analyte is selected from the group consisting of coliforms, allergens, mycotoxins, mold spores, bacterial spores, ricin, small pox, environmental contaminants, toxins, water additives, and agricultural markers.

9. A device for collecting and preparing a sample for direct analysis of anthrax, comprising:
a dispensing component having a housing defining a recess and including a dispensing end with a pore therethrough and an opposed open end;
an elongated member attachable inside the housing and having an attaching end, a swab end with an absorbent affixed thereon, and a length sufficient for the swab end to extend beyond the open end when attached to the dispensing component;
a sealable vial having a buffer and being attachable to the open end of the dispensing component;
means for attaching the elongated member to the housing; and,
means for attaching the vial to the dispensing component.

10. The device of claim 9 wherein the dispensing component further includes a releasable pore seal over the pore.

11. The device of claim 10 wherein the seal over the pore is selected from the group consisting of a removable strip, a cap, and a structure that snaps over the opening.

12. The device of claim 10 wherein the seal is a dropper cap attachable to the dispensing component.

13. The device of claim 12 wherein the dropper cap comprises means for attaching the cap to the dispensing member so the cap may be removed from the pore but remain tethered to the dispensing component.

14. The device of claim 13 wherein the means for attaching the elongated member to the housing comprises a face attached to the housing and extending across at least a portion of a cross-section of the housing.

15. The device of claim 14 wherein the face includes at least one opening for inserting the attaching end of the elongated member therein.

16. The device of claim 9 wherein the dispensing component, the elongated member, and the vial are produced by injection molding.

17. The device of claim 9 wherein the dispensing component, the elongated member, and the vial are fabricated from a material selected from the group consisting of polyethylene, polypropylene, polycarbonate, and polymetacrylate.

18. The device of claim 9 wherein the dispensing component, the elongated member, and the vial are fabricated from polypropylene.

19. The device of claim 9 wherein the absorbent is a material selected from group consisting of gauze, cotton, a sponge, polyurethane, and cellulose fiber.

20. The device of claim 9 wherein the device is capable of dispensing analysis-ready sample as drops.

21. A method of collecting and preparing a sample for analysis of an analyte, comprising:
(a) providing a device comprising:
(i) a dispensing component having a housing defining a recess, a dispensing end with a pore, and an opposed open end; an elongated member attached inside the housing and extending away from the dispensing end terminating in a swab end with an absorbent affixed thereon outside the open end; a dropper cap attached to the housing at the dispensing end; and
(ii) a vial having a buffer attachable to the open end of the dispensing component;
(b) collecting a test sample by contacting, with the absorbent, one of a surface and a fluid sample suspected of containing the analyte;
(c) releasing the test sample into the buffer by immersing the sample-containing absorbent in the buffer under agitation to form an analysis-ready sample; and,
(d) dispensing the analysis-ready sample into a procedure for analysis of the analyte.

22. The method of claim 21 further comprising wetting the absorbent with the buffer prior to the swabbing step.

23. The method of claim 21 wherein the diluting step includes releasing the collected sample in the buffer.

24. The method of claim 21 further comprising attaching the vial to the open end of the dispensing component after collecting the test sample on the absorbent.

25. The method of claim 21 wherein the dispensing step includes dispensing the analysis-ready sample into at least one test container for analysis of the analyte.

26. The method of claim 21 wherein the dispensing step includes introducing the diluted sample into a device employing a procedure selected from the group consisting of immunoassay, immunochromatography, radio immunoassay, optical immunoassay, enzyme immunoassay, and chemiluminescence.

27. The method of claim 21 wherein the dispensing step includes dispensing the analysis-ready sample into a lateral flow device that detects and optionally quantifies the analyte in the sample.

28. A method of collecting and preparing a sample for analysis of an anthrax analyte selected from the group consisting of anthrax endospores and the causative microorganism, comprising:
(a) providing a device comprising:
(i) a dispensing component having a housing defining a recess, a dispensing end with a pore, and an opposed open end; an elongated member attached inside the housing and extending away from the dispensing end terminating in a swab end with an absorbent affixed thereon outside the open end; a dropper cap attached to the housing at the dispensing end; and
(ii) a vial having a buffer attachable to the open end of the dispensing component;
(b) collecting a test sample by contacting, with the absorbent, one of a surface and a fluid sample suspected of being contaminated with an anthrax analyte;
(c) releasing the test sample into the buffer by immersing the sample-containing absorbent in the buffer under agitation to form an analysis-ready sample; and,
(d) dispensing the analysis-ready sample into an assay for the anthrax analyte.

29. The method of claim 28 wherein the dispensing step includes introducing the diluted sample into a device employing a procedure selected from the group consisting of immunoassay, immunochromatography, radio immunoassay, optical immunoassay, enzyme immunoassay, and chemiluminescence.

30. The method of claim 28 wherein the dispensing step includes dispensing the analysis-ready sample into a lateral flow device that detects and optionally quantifies the anthrax analyte in the sample.
